(19) United States
(12) Patent Application Publication
(10) Pub. No.: US 2020/0217545 A1
(43) Pub. Date: Jul. 9, 2020

(54) METHOD, SYSTEM AND APPARATUS FOR OPTIMISING ENERGY CONSUMPTION

(71) Applicant: ZEN ECOSYSTEMS IP PTY LTD, Box Hill, Victoria (AU)

(72) Inventors: Anthony FAVALORO, Bentleigh East, Victoria (AU); James MURACA, Hoppers Crossing, Victoria (AU); Grant Ian HATAMOSA, Bayswater North, Victoria (AU); Michael Isaac JOFFE, Richmond, Victoria (AU)

(21) Appl. No.: 16/637,788

(22) PCT Filed: Aug. 17, 2018
(86) PCT No.: PCT/AU2018/000139

§ 371 Date: Feb. 10, 2020

(30) Foreign Application Priority Data
Aug. 17, 2017 (AU) 2017903319

(51) Int. Cl. F24F 11/47; F24F 11/61; G06Q 50/06; F24F 11/56; F24F 11/63

(52) U.S. Cl. CPC F24F 11/47; F24F 11/61; F24F 2110/10; F24F 11/56; F24F 11/63; G06Q 50/06

(57) ABSTRACT

The present application relates to a method and system of dynamically responding to a Demand Response (DR) request of a commercial energy system to reduce energy consumption of at least one energy consuming appliance, equipment and/or device, and includes: providing the DR request with an associated priority, and controlling at least one control device operably connected to energy consuming appliances, equipment and/or devices of an individual building in accordance with predetermined criteria based on the associated priority.

### RELATED APPLICATIONS

This application claims priority to Australian Provisional Patent Application No. 2017903319 in the name of Zen Ecosystems IP Pty Ltd, which was filed on 17 Aug. 2017, entitled “Method and Apparatus for Optimising Energy Consumption” and the specification thereof is incorporated herein by reference in its entirety and for all purposes.

### FIELD OF INVENTION

The present invention relates to the field of energy consumption. In particular, the invention relates to a method, system and apparatus for optimising energy consumption of a building and/or energy consuming appliances, equipment or devices of a building. In one particular aspect, the present invention is suitable for use as a means for characterising the thermal response of a building. It will also be convenient to hereinafter describe the invention in relation to its use in providing a real time dynamic response to a remote demand response request, however it should be appreciated that the present invention is not limited to that use, only.

### BACKGROUND ART

Throughout this specification the use of the word “inventor” in singular form may be taken as reference to one (singular) inventor or more than one (plural) inventor of the present invention.

It is to be appreciated that any discussion of documents, devices, acts or knowledge in this specification is included to explain the context of the present invention. Further, the discussion throughout this specification comes about due to the realisation of the inventor and/or the identification of certain related art problems by the inventor. Moreover, any discussion of material such as documents, devices, acts or knowledge in this specification is included to explain the context of the invention in terms of the inventor's knowledge and experience and, accordingly, any such discussion should not be taken as an admission that any of the material forms part of the prior art base or the common general knowledge in the relevant art in Australia, or elsewhere, on or before the priority date of the disclosure and claims herein.

Heating, ventilation and air conditioning (HVAC) encompasses technology directed to the measurement and/or control of indoor environmental conditions to provide thermal comfort and acceptable indoor air quality. HVAC system design is an engineering discipline based on principles including those of thermodynamics, fluid mechanics, and heat transfer. HVAC is an important part of residential structures such as single standing family homes, apartment buildings, hotels and senior living facilities, as well as medium to large industrial and office buildings such as skyscrapers and hospitals. It is also utilised in onboard vessels, and in marine environments, where safe and healthy building conditions are regulated with respect to temperature and humidity, using fresh air from outdoors.

The development of HVAC systems and their components went hand-in-hand with the industrial revolution, and new methods of modernization, higher efficiency, and system control are constantly being introduced by companies and individuals worldwide. At present, energy consumption management has become an economic imperative issue where there is a greater need to optimise use of energy resources. There have been numerous attempts in the prior art to manage and optimise energy usage and examples follow.

As energy supplies become more expensive and/or volatile, suppliers and consumers have sought ways and means to reduce their respective energy consumption and energy costs. Many energy systems have allowed users to schedule how and when energy systems should be used. This applies to not only HVAC systems but also to other energy consuming appliances, equipment and/or devices such as hot water systems and lighting systems.

By way of example, a HVAC system may allow a user to set temperatures for different times of day, such as a “wake” time and temperature, an “away” time and temperature, a “return” time and temperature, and a “sleep” time and temperature. At the predetermined times, the system adjusts to the predetermined temperatures. However, these systems require a user to both configure them properly and, more importantly, adjust the times and temperatures to adapt to changing needs and concerns with respect to energy consumption or production. These scheduling systems do not take into account the amount of energy used, or the cost of the energy used. Hence, intelligent systems for adapting to changing energy costs and needs while achieving user goals with respect to energy consumption or production and costs have been developed.

Given that weather is a major variable impacting on home energy demand, the automatic adjustment of temperature may be conducted by a utility that provides power to the home based on weather information, but often such adjustments are based on incomplete or inaccurate weather information for the precise location of the home and do not factor in the occupant's personal preferences. In addition, these systems are generally not capable of accounting for the thermal characteristics of the particular building in which the thermostat is installed. As a result, such systems react to current weather conditions and temperature needs of the home, rather than performing pre-heating and/or pre-cooling based on forecast weather conditions and the energy characteristics of the home.

With a conventional energy management approach, a residence may manage its own energy. However, due to limitations of conventional energy management devices, such as thermostats and the like, it can be difficult for a residence to efficiently and effectively manage energy usage on its own. Furthermore, conventional thermostat systems, whilst aiming to maintain a desired temperature within a residence, are not generally precise in maintaining a particular temperature and thus may fluctuate through a temperature range. This fluctuation can result in varying energy consumption, and variable energy cost, just to maintain a particular temperature in the residence over time.

Furthermore, during peak energy demand periods, commercial energy systems that comprise utilities and service providers are often forced to purchase short-term energy resources at prices that are significantly higher than average and pass on the high costs to its energy customers. Within these commercial energy systems, when utilities and service providers fail to maintain adequate energy resources, this can lead to power outages that affect the general public and can tarnish the reputation of the utilities and service providers and adversely affect their business. As a result, utility and service providers often lose millions of dollars every day in order to maintain adequate energy resources. In order to manage peak energy demand periods, some utilities and service providers establish reduction compensation programs and pay consumers to temporarily reduce their energy consumption during peak energy demand periods. Advantageously, consumers electing to participate in a curtailment event (i.e., compensation program) may be incentivized by being able to purchase energy during peak energy demand periods at energy costs lower than normally available. However, due to the high volatility of wholesale energy prices and the absence of energy management systems for determining real-time information tracking energy usage, consumer participation in reduction compensation programs is limited.

In the energy supply market, a demand response (DR) request can be generated either from an external utility company as a request to relieve strain on the local power grid, or from a facilities manager or store manager to reduce energy usage in a specific building during high cost peak energy use periods. The system response to a DR event is to limit the output of the HVAC system to immediately reduce the energy consumed by the system. Predicting exactly how an energy system responds to a DR request can be problematic.

U.S. Pat. No. 9,471,082 (Sloop et al) describes a method using an algorithm as well as the observed thermal response of a building to optimise the energy consumption of a HVAC system. The algorithm requires thermal response coefficients based on energy characteristics of the building to be inputted as a first step, and therefore would require a certain amount of initial “setup” time where the system is offline, which is cumbersome and inefficient.

US patent publication No. 2014/0039686 (Corbin) describes a method of meeting energy consumption goals which involves creating a simulation model of a HVAC system by monitoring the response of the system while performing test heating/cooling/free-float HVAC steps. This method relies on test steps to characterise the HVAC system, and therefore would require a certain amount of initial “setup” time where the system is offline, which is cumbersome and inefficient.

U.S. Pat. No. 8,019,567 (Steinberg et al) describes a method of measuring inside temperature and comparing that with outside temperature to generate a baseline for the expected HVAC system ramp rate. This baseline is used to identify any deviations and assess HVAC system health. This method requires the HVAC system to be in operation during a ramping period and therefore would require a certain amount of initial “setup” time where the system is offline, which is cumbersome and inefficient.

U.S. Pat. No. 7,848,900 (Steinberg et al) describes a method of characterising an operational efficiency of an HVAC system by monitoring the rate of change of an internal temperature at a first location when the system is both on and off and relating these to the associated external temperature of the building. It is considered that this system would need to contrive the events that would result in the model being generated in the first instance. This limits the system to a cumbersome and inefficient process.

U.S. Pat. No. 9,008,846 (Pan et al) describes a method of implementing a thermostat lockout using pin code storage, and a method of unlocking the device. In this respect, property-management or lock-setting thermostats have maximum and minimum set points locked in to prevent abuse of management-provided heating and/or air conditioning. An ePROM or similar internal memory device stores heating and cooling limit parameters that are set in by a technician at the time of installation. A plug-in flash memory module contains an unlock code to match the unlock code stored in said ePROM, to unlock the thermostat and allow the settings to be adjusted; when said flash memory module is removed the thermostat reverts to its lock condition. The thermostat can also respond to unusual rates of change of temperature to block furnace or A/C operation temporarily. However, due to a need to respond to a DR event within minutes of notification from a utility/authority, the disclosed method and system is not suitable or designed for accommodating demand response and is silent on this aspect.

U.S. Pat. No. 6,868,293 (Schurr et al) describes a method of implementing demand response using a remote request. The disclosed method is directed toward addressing a need for customizing curtailment events for individual consumer users and providing real-time notification and monitoring of curtailment events. It also identifies a need for a system and method for remotely controlling a thermostat device in a residence to achieve efficient energy management. In essence, the disclosed system performs energy usage management within a network, comprising: a thermostat associated with an energy consuming entity (such as a residence), a server remote from the energy consuming entity for performing one or more energy curtailment management operations within the network, the server being communicatively connected to the thermostat over the network and having a software application thereon for remotely controlling the thermostat in accordance with a particular energy curtailment management operation; and a database associated with the server for storing curtailment event information relating to the network. However, the disclosed method and system does not provide or cater to a solution for demand response in which there are varying levels of urgency of response.

U.S. Pat. No. 7,908,117 (Steinberg et al) describes a method of determining if an HVAC system is on or off and relates this to the expected behaviour, based on historical measurements, following a demand response request. The disclosed solution comprises systems and methods for verifying the occurrence of a change in operational status for climate control systems. The climate control system measures temperature at least at a first location conditioned by the climate control system. One or more processors also receive measurements of outside temperatures from at least one source other than the climate control system, and compares the temperature measurements from the first location with expected temperature measurements. The expected temperature measurements are based at least in part upon past temperature measurements obtained by the climate control system and the outside temperature measurements. A server transmits changes in programming to the climate control system based at least in part on the comparison of the temperature measurements with the expected temperature measurements. However, the disclosed method and system does not provide or cater to a solution for demand response in which there are varying levels of urgency of response.

Many prior art systems focus on optimizing and controlling the energy consumption of a building, by either pre-populating thermal response coefficients from known building characteristics, or using the HVAC system directly to drive a monitored response, and thus build a thermal model of the system. This forms a limitation in that the act of prompting a user for specific building information, or taking the HVAC system offline to contrive a known event, is both inefficient and cumbersome.

US patent publication No. US 2011/0160913 (Parker et al) discloses a method and system of determining and displaying energy savings from an HVAC system operating in an energy saving mode. The HVAC system is operated to maintain a comfort mode temperature during a learning period. The energy consumed by the HVAC system at multiple outside ambient conditions during the learning period is determined. The correlation between a specific ambient condition and energy consumed by the HVAC system is determined. The HVAC system is run to maintain an energy saving setpoint temperature. The energy consumed by the HVAC system is determined at an ambient condition while maintaining the energy saving setpoint temperature. The energy savings are calculated as a function of the difference between the energy that would have been consumed by the HVAC system at the ambient condition based on the determined correlation and the energy consumed by the HVAC system while maintaining the energy saving setpoint temperature at the ambient condition.

U.S. Pat. No. 6,478,233 (Shah) discloses a thermal comfort controller using various recovery methods to change the indoor temperature to meet set points in a setup/setback schedule to maintain thermal comfort for occupants of an enclosure. The thermal comfort controller further comprises an apparatus to determine the expected energy savings when modifying the setup/setback schedule for the enclosure in which the temperature controller is used. The energy savings information may be displayed to the enclosure occupant for further consideration.

The prior art of Parker et al and Shah do not prevent variability to the control of a building HVAC system when used in addition to controlling a building HVAC system and other users may not be placed under control of a device effecting the environment.

US patent publication No. US 2014/0095410 (Chen et al) discloses a method for demand response management and includes determining a number of available demand response events and a number of opportunities available to issue the available demand response events. A priority for each demand response event is provided and a threshold value for each demand response vent is determined. A highest priority demand response event among the available demand response events whose threshold value is lower than an observed value of a selected demand response trigger is selected and control signals to utilize the selected demand response event for a current opportunity are transmitted to customer sites. Essentially, Chen et al provides a timely creation of a demand response request to improve energy consumption of a commercial building participating in a DR program and specifically, Chen et provides a method to prioritise a queue of demand response requests.

European patent publication No. EP 2639920 (Accenture Global Services Limited) discloses a method and system for reducing demand on a power grid through demand side management includes receiving assigned priorities from a user for smart appliances (106) and for appliances plugged into sockets (104) of one or more smart plugs of the user, the assigned priorities indicative of a user-preferred sequence for disconnection of, or adjustment of power to, the appliances from the power grid. The system determines whether to disconnect or adjust power to at least one of the appliances of the user; and selects at least one of the appliances according to the assigned priorities to reduce demand on the power grid. The system sends one or more commands, the one or more commands indicative to the one or more smart plugs to disconnect or adjust power to the selected at least one of the appliances based on selecting at least one of the appliances. A user-centric method is provided to prioritise control of appliances in a site or grouping that is adhering to a demand response program. This is achieved by way of control over an appliance bases on its assigned priority so as to improve the efficiency of the adherence to a demand response request.

The preceding discussion of background art is intended to facilitate an understanding of the present invention only. The discussion is not an acknowledgement or admission that any of the material referred to is or was part of the common general knowledge as at the priority date of the application.

### SUMMARY OF INVENTION

It is an object of the embodiments described herein to overcome or alleviate at least one of the above noted drawbacks of related art systems or to at least provide a useful alternative to related art systems.

In a first aspect of embodiments described herein there is provided a method of optimising energy management of a building heating, ventilation and air conditioning (HVAC) system, the method comprising the steps of:

monitoring a set of actual building environment parameters of at least one individual building in response to a naturally occurring impulse of the HVAC system;

generating a thermal profile of the at least one individual building using the monitored set of actual building environment parameters as inputs;

wherein the generated thermal profile comprises a calculation of energy required to maintain a predetermined temperature set point as a function of the difference between source energy, Eᵢₙ, put into the at least one building and drain energy, Eₗₒₛₜ, lost from the building.

The actual building environment parameters may comprise one or a combination of:

air temperature of the building;

one or more surface temperatures of the building;

relative humidity;

movement detection;

HVAC schedule information;

building energy cost profile information;

one or more remote DR request;

predicted regional weather;

building occupant comfort coordination information.

The actual building environment parameters may further comprise output of the generated thermal profile.

The naturally occurring impulse may correspond to one or a combination of:

at least one remote DR request event;

lights being turned on/off at the start/end of the day;

building occupants arriving/departing at the start/end of the day;

at least one heat-producing system that is independent of the HVAC system switched on/off within the building;

the HVAC system being switched on/off at the start/end of the day.

The source energy, Eᵢₙ, put into the at least one building may comprise the sum of heat received from an external energy supplier and heat generated by people and equipment occupying the building.

Furthermore, the drain energy, Eₗₒₛₜ, lost from the building may comprise:

(Tinside building−Toutside building)×Insulation Factor,

where T is in units of ° C. and Insulation Factor is in units of J/° C.

The Insulation Factor can be dependent on one or a combination of the following building attributes:

one or more of presence, absence, quality of insulation in roof/wall cavities;

air leaks directly to outside;

external glass;

orientation of building with respect to direct sunlight;

any shade;

abnormal airflow/wind;

altitude.

The method as set out above and described herein may further comprise the step of:

repeating the steps of monitoring a set of actual building environment parameters and generating a thermal profile of a building for a plurality of individual buildings to provide a set of resultant generated thermal profiles and;

integrating the resultant generated thermal profiles to provide at least one regional energy usage trend.

In another aspect of embodiments described herein there is provided a building heating, ventilation and air conditioning (HVAC) energy management system, which comprises:

environmental monitoring equipment for monitoring a set of actual building environment parameters of at least one individual building following a naturally occurring impulse of the HVAC system;

a computer server comprising data processing components for generating a thermal profile of the at least one individual building using the monitored set of actual building environment parameters as inputs;

wherein the generated thermal profile comprises a calculation of energy required to maintain a predetermined temperature set point as a function of the difference between source energy, Eᵢₙ, put into the at least one building and drain energy, Eₗₒₛₜ, lost from the building.

Preferred embodiments of the invention provide apparatus adapted to optimise energy management of a building heating, ventilation and air conditioning (HVAC) system, said apparatus comprising:

processor means adapted to operate in accordance with a predetermined instruction set,

said apparatus, in conjunction with said instruction set, being adapted to perform the method steps as set out above and described herein.

In yet a further aspect of embodiments described herein there is provided a computer program product comprising:

a computer usable medium having computer readable program code and computer readable system code embodied on said medium for optimising energy management of a building heating, ventilation and air conditioning (HVAC) system within a data processing system, said computer program product comprising computer readable code within said computer usable medium for:

monitoring a set of actual building environment parameters of at least one individual building following a naturally occurring impulse of the HVAC system; and

generating a thermal profile of the at least one individual building using the monitored set of actual building environment parameters as inputs;

wherein the generated thermal profile comprises a calculation of energy required to maintain a predetermined temperature set point as a function of the difference between source energy, Eᵢₙ, put into the at least one building and drain energy, Eₗₒₛₜ, lost from the building.

In still a further aspect of embodiments described herein there is provided a method of dynamically responding to a Demand Response (DR) request of a commercial energy system to reduce energy consumption of at least one energy consuming appliance, equipment and/or device, the method comprising the steps of:

providing the DR request with an associated priority;

controlling at least one control device operably connected to energy consuming appliances, equipment and/or devices of an individual building in accordance with predetermined criteria based on the associated priority.

Preferably, the priority is selected from a plurality of levels. Furthermore, the associated priority may be selected from one or a combination of the following levels:

high;

medium, or

low.

In the method set out above, the predetermined criteria may comprise one or a combination of:

complete lock out of a user from the at least one control device of the individual building for a high priority DR request;

invoking a first restricted set point range of the at least one control device for a medium priority DR request with an option for the user to opt out of the DR request;

invoking a second restricted set point range of the at least one control device for a low priority DR request with an option for the user to opt in to the DR request.

The predetermined criteria may further comprise one or a combination of:

a PIN code being required to unlock a user from the at least one control device of the individual building for a high priority DR request;

reporting a decision by the user to opt out of a medium priority DR request to the originator of the DR request;

the decision to opt in to a low priority DR request being based on circumstances local to the individual building.

Preferably, the first restricted set point range is more restrictive than the second restricted set point range.

In preferred embodiments, the predetermined criteria may further comprise one or a combination of:

turning the at least one energy consuming appliance, equipment and/or device off altogether;

turning off a heating/cooling element of the at least one energy consuming appliance, equipment and/or device and keeping a fan of the at least one energy consuming appliance, equipment and/or device running.

The at least one energy consuming appliance, equipment and/or device of the method set out above may be one or a combination of:

a HVAC system;

a lighting system;

a hot water service/system.

The at least one control device may comprise a thermostat.

In still another aspect of embodiments described herein there is provided a building energy management system adapted to dynamically respond to a Demand Response (DR) request of a commercial energy system to reduce energy consumption of at least one energy consuming appliance, equipment and/or device, the system comprising:

computer data network means for providing the DR request with an associated priority level;

at least one control device operably connected to the at least one energy consuming appliance, equipment and/or device of an individual building adapted to receive the DR request and control the at least one energy consuming appliance, equipment and/or device of the building in accordance with predetermined criteria based on the associated priority level.

In the building energy management system as set out above and described herein, the at least one energy consuming appliance, equipment and/or device may be one or a combination of:

a HVAC system;

a lighting system;

a hot water service/system.

In the building energy management system as set out above, in accordance with preferred embodiments, the at least one control device comprises a thermostat.

Preferred embodiments of the invention may also include apparatus adapted to dynamically respond to a Demand Response (DR) request of a commercial energy system to reduce energy consumption, said apparatus comprising:

processor means adapted to operate in accordance with a predetermined instruction set,

said apparatus, in conjunction with said instruction set, being adapted to perform the method steps as set out above and described herein.

In another aspect of embodiments described herein, there is provided a computer program product comprising:

a computer usable medium having computer readable program code and computer readable system code embodied on said medium for dynamically responding to a Demand Response (DR) request of a commercial energy system to reduce energy consumption of a building within a data processing system, said computer program product comprising computer readable code within said computer usable medium for:

providing the DR request with an associated priority level;

controlling at least one energy consuming appliance, equipment and/or device of an individual building in accordance with predetermined criteria based on the associated priority level.

In the computer program product as described with embodiments herein, the at least one energy consuming appliance, equipment and/or device is one or a combination of:

a HVAC system;

a lighting system;

a hot water service/system.

In essence, embodiments of the present invention stem from the realization that rather than relying on weather data or energy characteristics of the building in the first instance, or requiring a contrived setup time where the HVAC system is driven in a certain known way to generate a system model, embodiments of the current invention monitor parameters such as for example, the air and surface temperatures of a building following a naturally occurring impulse as an input into generating the thermal profile of the building. This process is less impactful on the HVAC system, and therefore improves efficiency and overall value of the solution. Furthermore, embodiments of the current invention allow for prioritised control actions in real-time response to DR requests of a commercial energy system.

Other aspects and preferred forms are disclosed in the specification and/or defined in the appended claims, forming a part of the description of the invention.

Advantages provided by the present invention comprise the following:

Embodiments of the invention incorporate the use of a “naturally” occurring impulse to provide characterisation and control. In particular, embodiments monitor the response of the system during an impulse event that would occur from day to day as part of the “natural” system operation and therefore, building up the necessary information to establish the thermal model of the system without requiring any extra input steps from either the HVAC system or the users directly.

Prior art generally includes descriptions of methods of responding to a demand response event by modifying HVAC control. However, typically this can be overridden by a local building occupant and therefore ignored. Given there is no mechanism to triage the urgency of these requests, this may or may not have a significant impact on the originator of the demand response. By associating a level of urgency with a given demand response message, and providing the ability for the thermostat to accommodate the priority of this message with an associated level of thermostat lockout, there is greater control over the level of responsiveness that can be assumed by the originator of the demand response.

Embodiments of the present invention improve the optimisation of energy management of a building HVAC system by introducing stepwise lockout to a thermostat. The introduction of a stepwise lockout will remove variability to the control of the building HVAC system when used in addition to controlling a building HVAC system. Further, the stepwise lockout method provides admin level users the ability to fully prevent other users to control a device, restrict control of a device via limiting the control range of certain users, and limiting the time of a control change which will be adhered to.

Embodiments of the present invention provide adherence to an existing demand response as opposed to creation of a DR request.

Embodiments of the present invention focus on the monitoring of the commercial building energy consumption so that the target energy savings to adhere to the received demand response request may be achieved.

In addition, embodiments of the present invention also remove the variability of reducing the energy consumption of a commercial building by implementing a stepwise lockout method.

Embodiments of the present invention do not need to focus on when devices are turned on or off during a demand response event but instead focus on preventing/limiting users from controlling a device during a demand response event.

Embodiments of the present invention restrict control of a device by way of limiting the control range of certain users and limiting the time of a control change, which will be adhered to.

Further advantages, scope of applicability of embodiments of the present invention will become apparent from the detailed description given hereinafter. However, it should be understood that the detailed description and specific examples, while indicating preferred embodiments of the invention, are given by way of illustration only, since various changes and modifications within the spirit and scope of the disclosure herein will become apparent to those skilled in the art from this detailed description.

### BRIEF DESCRIPTION OF THE DRAWINGS

Further disclosure, objects, advantages and aspects of preferred and other embodiments of the present invention may be better understood by those skilled in the relevant art by reference to the following description of embodiments taken in conjunction with the accompanying drawings, which are given by way of illustration only, and thus are not limitative of the disclosure herein, and in which:

FIG. 1 is a system diagram that illustrates a HVAC system in accordance with preferred embodiments of the present invention;

FIG. 2 illustrates a range of temperature responses to thermostat set points corresponding to a variety of incumbent building parameters that may contribute to a building characterisation for energy management;

FIG. 3 illustrates a set of temperature responses showing energy savings in accordance with preferred embodiments of the invention;

FIG. 4 is a flow chart illustrating a method of dynamic response to a DR request in accordance with a preferred embodiment of the invention;

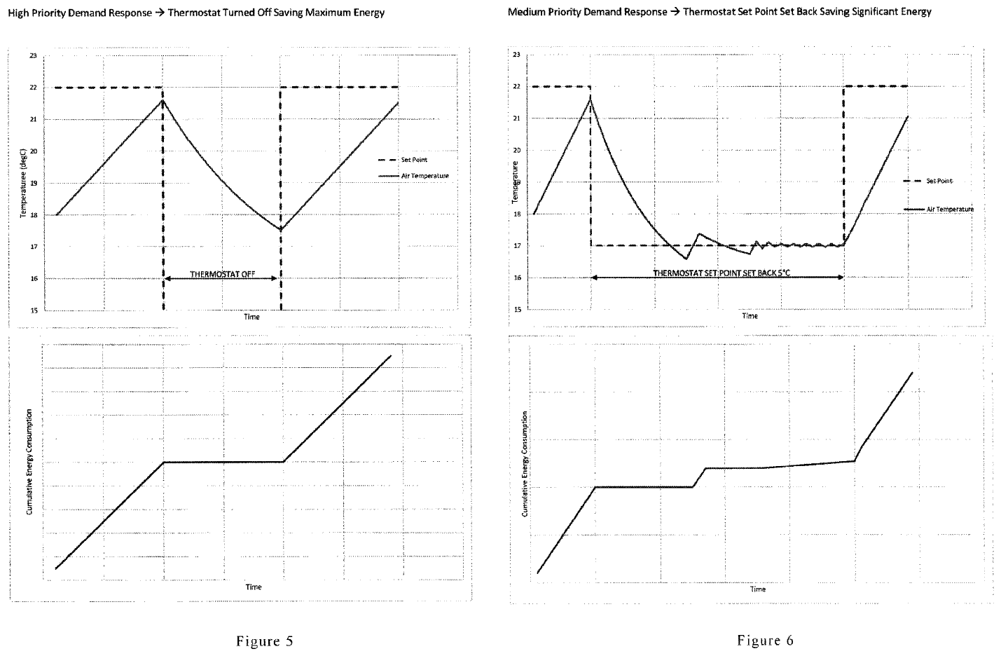

FIGS. 5, 6 and 7 illustrate a set of temperature responses with corresponding cumulative energy consumption results produced by a method of dynamic response to a DR request in accordance with a preferred embodiment of the invention.

### DETAILED DESCRIPTION

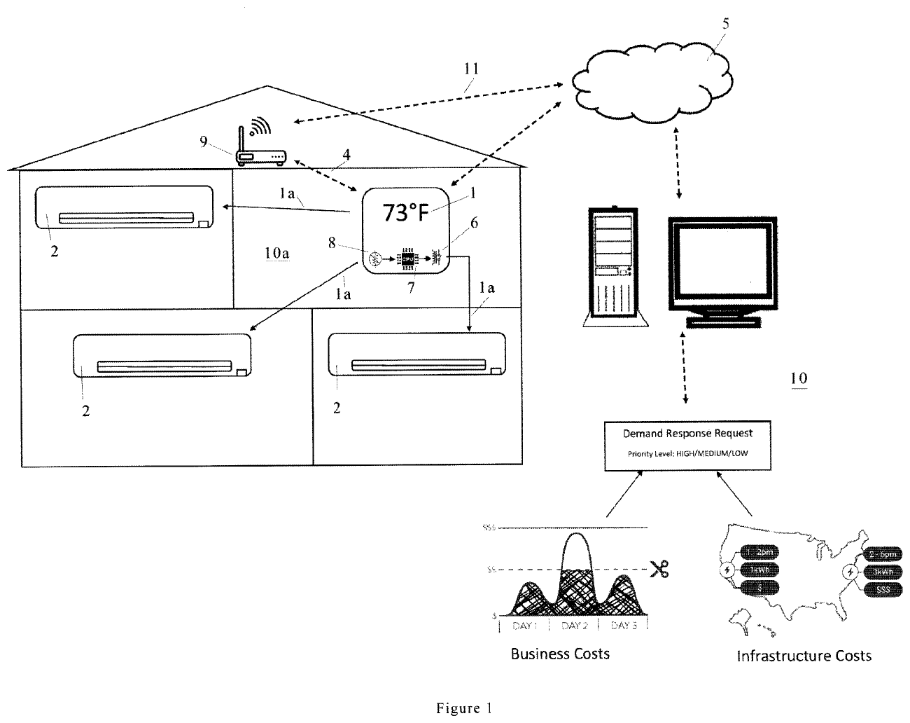

In a first described embodiment of the invention several components combine to complete an overall system. With reference to FIG. 1, an individual building energy management system 10 is shown. A building thermostat 1 is provided and can be used to control the comfort levels of the building occupants by way of controlling the building Heating, Ventilation and Air Conditioning (HVAC) system 10a. The thermostat 1 has wired connections 1a to the heating, cooling or ventilation appliances 2, a set of control relays 6 and sensors 8 and a microprocessor 7 which controls the relays 6 based on input from the sensors 8. The microprocessor 7 receives input from the user as to the desired environmental conditions (setpoint, heating mode, fan speed, switch-on time), from two sources, either directly through the front panel of the thermostat 1, or through a wireless link 4 with a home automation system 9 and/or computing server 5.

The thermostat 1 can be placed in several ‘lock’ modes which vary in their impact on occupant comfort levels. At one extreme of lock modes, the HVAC system 10a can be turned completely off, and at the other extreme the allowable set points are merely restricted to a configurable range. Certain lock modes can also be implemented to require the local input of a pin code which may set from the computing server 5.

The home automation system 9 is connected via a network link 11 to the computing server 5 located remotely to the thermostat 1. The computing server 3 comprises a large data collection and storage device as well as several data processing components used to prepare algorithmic outputs to drive the operation of the building thermostat and therefore the building HVAC system 10a.

The data processing components of the computing server 5 may include one or a combination of the following as inputs:
internal air/surface temperatures from the thermostat;
relative humidity values from the thermostat;
movement detection feedback from the thermostat;
the building thermal response profile;
the building schedule coordinator;
the building energy cost profile;
any remote requests for a demand response event;
regional weather prediction component;
the building occupant comfort coordinator.

There is also a client computing device 3 which can be used to input information directly into the computing server 5. This would comprise information such as local utility energy cost, usage profiles and, demand response events generated externally to the client computing device.

### Thermal Profiling of System

As noted, the events that stem from a system response to a DR request, namely, the limiting of output of the HVAC system to immediately reduce the energy consumed by the system, are very impactful on the thermal state of the individual building system 10. As such they can be monitored in order to characterise a thermal model of the system which in turn can be used to predict the behaviour of the system for future events. Other impactful events that could be monitored to feed into a thermal model may include for example:
Lights being turned on/off at the start/end of the day
Building occupants arriving/departing at the start/end of the day
Any heat-producing systems switched on/off within the building (non HVAC)
The HVAC system being switched on/off at the start/end of the day

As well as being impactful to the thermal state of the system, each of these events noted above can also be described as being “naturally” occurring in that they are events that would occur independent of the requirement to thermally characterise the system.

### Energy Optimisation

Energy is required in order to drive building occupant comfort levels to an acceptable level using the building HVAC system 10a. There is an associated temperature set point on the HVAC system thermostat 1 which defines this comfort level, and the energy required to achieve this set temperature is a function of the energy put into the system and the energy lost from the system and can be defined as part of the following formula, where:

Energy Required to Maintain Occupant Comfort Level (Tₛₑₜ₋ₚₒᵢₙₜ)=E_{In}−E_{Lost}

where,

E_{In}=Heat of Heating System+Heat generated by occupants (people and equipment)

and

E_{Lost}=(T_{inside}−T_{outside})*Insulation Factor

where Insulation Factor (J/° C.) is dependent on:
presence/absence/quality insulation in roof/wall cavities,
air leaks directly to outside,
external glass,
orientation of building with respect to direct sunlight and any shade, abnormal airflow/wind, altitude

Once the energy required to maintain a given set point is properly characterised, the control loop used to drive the HVAC system 10a can include a predictive element, rather than being purely reactive. Resulting in minimising temperature oscillation throughout the day, as temperature overshoot is reduced by decoupling the dependence on the inherent lag in any given building HVAC system.

With an understanding of the thermal characteristics of the building, a pre-heating/cooling time can be accurately calculated at the beginning of a day, in preparation for the arrival of building occupants, rather than roughly estimated which is often inefficient and therefore unnecessarily costly.

Finally, the significant volumes of data collected in the preparation of the building thermal profiles can be expanded on a regional scale with algorithms defined to identify energy usage trends across the country, and specifically regions of energy wastage versus regions of energy efficiency.

### HVAC System Maintenance

Once an understanding of the thermal response of the building is properly quantified, deviations from this baseline can be used to diagnose potential issues with the system as a whole, and pre-emptively signal when a fault has occurred.

By way of example, HVAC system health can be quantified by:
Number of times per day the HVAC system switches on active elements such as fans or compressors;
Comparing expected Vs actual “Energy Required to Maintain Setpoint” for a given season/external temperature to quantify HVAC system fault directly;
Comparing expected Vs actual “Energy Required to Maintain Setpoint” for a given season/external temperature to quantify building insulation failure/degradation;
Regional information regarding system health may highlight issues with regional service procedures or personnel.

In essence the above described embodiment of the invention uses a connected building thermostat in combination with naturally occurring events (impulses) to characterise the thermal response of the building.

This facilitates the optimisation of the energy consumed by the building Heating Ventilation and Air Conditioning (HVAC) system, which results in significant HVAC-related company cost savings.

As well as being impactful to the thermal state of the system, a DR request event can also be described as being “naturally” occurring, in that it is an event that would occur independent of the requirement to thermally characterise the system. It is to be noted that this removes inconvenience for building owners, as well as setup time during system install.

Once the energy required to maintain a given set point is properly characterised, the control loop used to drive the HVAC system can include a predictive element, rather than being purely reactive, which can be leveraged in a number of different ways to minimise energy consumption.

Once the thermal characteristics of a given building are known, the response to any given input stimulus provided by the HVAC system can be anticipated and predicted. Knowledge of the expected response to a given stimulus can be used to optimise the time at which the HVAC system is activated to pre-heat or pre-cool a building to a desired temperature set point, thus optimising the cost associated with this action

Deviations from this expected behaviour can be used to assess the relative health of the building HVAC system over time, including factors impacting energy inputs (the HVAC hardware) as well as energy outputs (building infrastructure). Thus significant HVAC related cost reductions can be achieved

Similarly, the significant volumes of data collected in the preparation of the building thermal profiles can be expanded on a regional scale with algorithms defined to identify energy usage trends across the country, and specifically regions of energy wastage versus regions of energy efficiency.

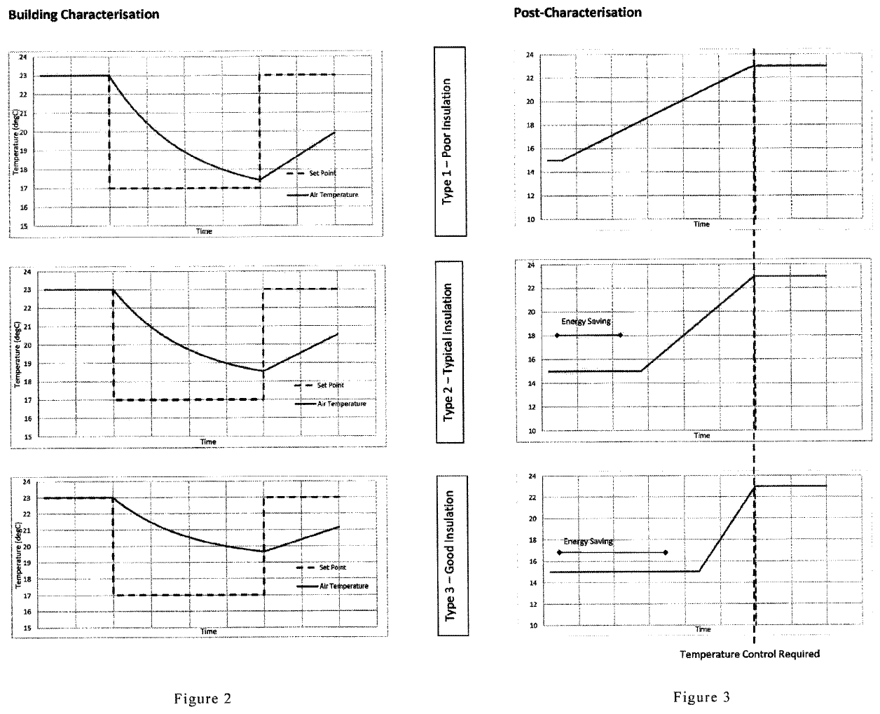

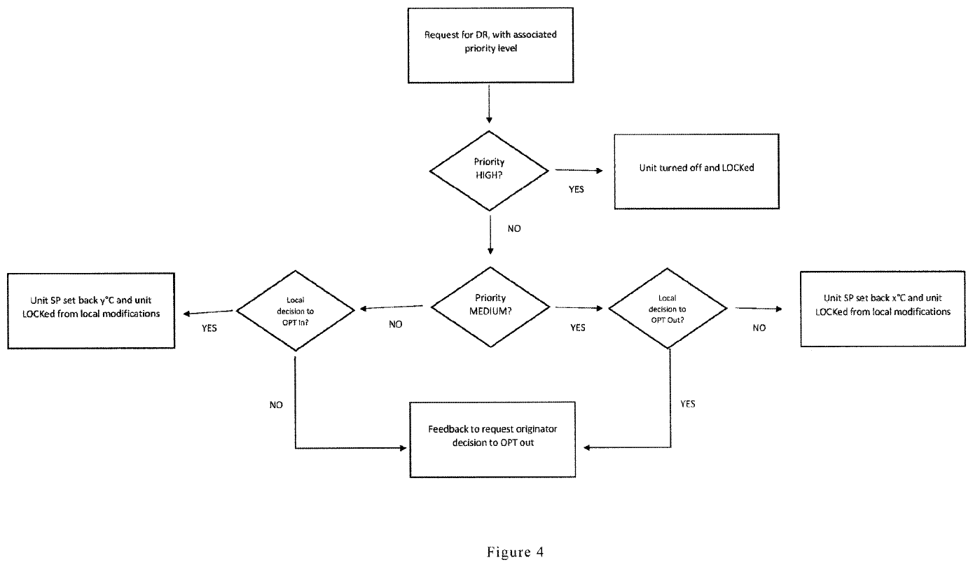

By way of example, as shown in FIG. 2, a range of temperature responses to thermostat set points is depicted respectively for poor, typical and good insulation. These may serve to contribute to the building classification as a monitored building parameter. The resultant energy savings that stem from this monitoring is shown in FIG. 3.

In a second described embodiment of the invention several components combine to complete an overall system. With reference again to FIG. 1, there is a building thermostat 1 that can be used to control the comfort levels of the building occupants by way of controlling the building Heating, Ventilation and Air Conditioning (HVAC) system 10a. The thermostat 1 has wired connections 1a to the heating, cooling or ventilation appliances 2, a set of control relays and sensors and a microprocessor which controls the relays based on input from the sensors. The microprocessor receives input from the user as to the desired environmental conditions (setpoint, heating mode, fan speed, switch-on time), from two sources, either directly through the front panel of the thermostat 1, or through a wireless link 4 with a home automation system and/or computing server 5.

The thermostat 1 can be placed in several ‘lock’ modes which vary in their impact on occupant comfort levels. At one extreme of lock modes, the HVAC system 10a can be turned completely off, and at the other extreme the allowable set points are merely restricted to a configurable range. A lock mode can also be implemented to require the local input of a pin code which is set from the computing server.

The home automation system is connected via a network link to the computing server 5 located remotely to the thermostat 1. The computing server 5 is comprised of a large data collection and storage device as well as several data processing components used to prepare algorithmic outputs to drive the operation of the building thermostat and therefore the building HVAC system.

Again, the data processing components of the computing server may include one or a combination of the following as inputs:
internal air/surface temperatures from the thermostat;
relative humidity values from the thermostat;
movement detection feedback from the thermostat;
the building thermal response profile;
the building schedule coordinator;
the building energy cost profile;
any remote requests for a demand response event;
regional weather prediction component;
the building occupant comfort coordinator.

There is also a client computing device which can be used to input information directly into the computing server 5. This may comprise information such as local utility energy cost, usage profiles and demand response events generated externally to the client computing device.

### Demand Response

As noted above, a demand response request can be generated either from an external utility company as a request to relieve strain on the local power grid, or from a facilities manager or national store manager to reduce energy usage of a building during high cost peak energy use periods.

This request can have an associated priority level, ranging from high to low priority/urgency. The priority may be determined based on how close to a blackout scenario the grid is, or how high energy prices have become. In the case of a high priority demand response request, the thermostat 1 can completely lockout the user, either requiring a PIN code to access the thermostat 1 or not. The thermostat 1 can either be turned off completely, or the set point setback to a “safe” level where the HVAC system 10a will remain off unless the internal air temperature conditions changed to an unacceptable level, defined by the computing server 5.

Medium priority demand response requests may result in a restricted set point range, with a setback from the external temperature of the building or, more accurately, setback from the set-point of the thermostat configured to a level that is in line with the level of energy saving required from the request. Alternatively, there could be an option to “opt-out” of the request, and this decision, made locally, could be fed back to the computing server 5.

Low priority demand response requests may result in a less restricted set point range, with a less severe setback from the external temperature of the building. Again, it is more accurate to state this as setback from the set-point of the thermostat. Alternatively, there could be an option to “opt-in” to the request, so that the request is not implemented on the thermostat automatically, and the decision made depending on local circumstances.

### Demand Response Vs Occupant Comfort

The decision to “opt-in” or “opt-out” of a demand response request can be coupled to occupant comfort levels which can be included into the control loop. Alternative methods of assessing occupant comfort levels exist. One solution could include an algorithm located on the computing server 5 to generate a relative level based on a comfort level scale. Another option is to include in the feedback loop a mechanism for building occupants to identify their level of comfort directly in a form of real-time occupant opinion polling.

Accordingly, this embodiment of the invention provides a means to dynamically respond in real-time to a remote Demand Response (DR) request to reduce building Heating Ventilation and Air Conditioning (HVAC) energy consumption, by way of managing local control of the building HVAC thermostat to varying levels of rigidity, depending on the urgency of the request. Where the higher the priority of the request, the more severe the limitation of the lockout.

A demand response (DR) request in the context of a building HVAC system 10a, is a request to reduce building energy consumption by scaling back the output of the HVAC system. This demand request can be generated either from an external utility company as a request to relieve strain on the local power grid, or from a facility manager or national store manager to reduce energy usage of a building during high cost peak energy use periods.

In this embodiment of the invention a given demand response would have an associated priority level, ranging from high to low priority/urgency. In the case of a high priority demand response request, the thermostat could completely lockout the user, either requiring a PIN code to access the thermostat or not. The thermostat could either be turned off completely, or the set point setback to a “safe” level where the HVAC system would remain off unless the internal air temperature conditions changed to an unacceptable level.

Medium priority demand response requests could result in a restricted set point range, with a setback from the external temperature of the building (set-back from the original set point of the thermostat) configured to a level that is in line with the level of energy saving required from the request. Alternatively, there could be an option to “opt-out”of the request, and this decision, made locally, could be fed back to the request originator.

Low priority demand response requests could result in a less restricted set point range, with a less severe setback from the external temperature of the building (set-back from the original set point of the thermostat). Alternatively, there could be an option to “opt-in” to the request, so that the request would not be implemented on the thermostat automatically, and instead the decision made depending on local circumstances.

By increasing the flexibility in the demand response solution, the level of subscription to the demand response concept is likely to be improved, given occupant comfort will only be compromised to the level that is required/requested from the demand response originator. Similarly, as the urgency of the demand response increases, so too does the feedback requirement from the originator so that they can properly manage the factors that led to the demand response request. This embodiment provides this feedback, scaled such that the higher the priority of the request, the more deterministic the behaviour of the building thermostat in response.

Prior art describes methods of responding to a demand response event by modifying HVAC control, however typically this can be overridden by a local building occupant and therefore ignored. Given there is no mechanism to triage the urgency of these requests, this may or may not have a significant impact on the originator of the demand response.

By associating a level of urgency with a given demand response message, and providing the ability for the thermostat to accommodate the priority of this message with an associated level of thermostat lockout, there is greater control over the level of responsiveness that can be assumed by the originator of the demand response.

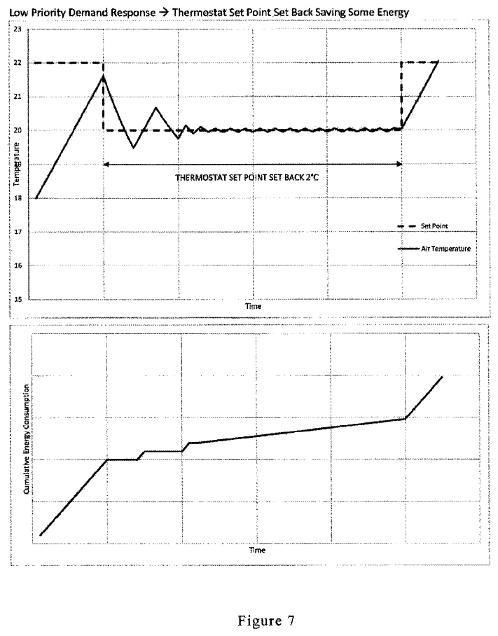

FIGS. 5, 6 and 7 illustrate a set of responses with corresponding cumulative energy consumption results produced by the above described method of dynamic response to a DR request in accordance with a preferred embodiment of the invention. FIG. 5 shows a response to a high priority DR request, whereas FIGS. 6 and 7 show the response to a medium and low priority DR request, respectively.

While this invention has been described in connection with specific embodiments thereof, it will be understood that it is capable of further modification(s). This application is intended to cover any variations uses or adaptations of the invention following in general, the principles of the invention and including such departures from the present disclosure as come within known or customary practice within the art to which the invention pertains and as may be applied to the essential features hereinbefore set forth.

As the present invention may be embodied in several forms without departing from the spirit of the essential characteristics of the invention, it should be understood that the above described embodiments are not to limit the present invention unless otherwise specified, but rather should be construed broadly within the spirit and scope of the invention as defined in the appended claims. The described embodiments are to be considered in all respects as illustrative only and not restrictive.

Various modifications and equivalent arrangements are intended to be included within the spirit and scope of the invention and appended claims. Therefore, the specific embodiments are to be understood to be illustrative of the many ways in which the principles of the present invention may be practiced. In the following claims, any means-plus-function clauses are intended to cover structures as performing the defined function and not only structural equivalents, but also equivalent structures. For example, although a nail and a screw may not be structural equivalents in that a nail employs a cylindrical surface to secure wooden parts together, whereas a screw employs a helical surface to secure wooden parts together, in the environment of fastening wooden parts, a nail and a screw are equivalent structures.

The following sections I-VII provide a guide to interpreting the present specification.

### I. Terms

The term “product” means any machine, manufacture and/or composition of matter, unless expressly specified otherwise.

The term “process” means any process, algorithm, method or the like, unless expressly specified otherwise.

Each process (whether called a method, algorithm or otherwise) inherently includes one or more steps, and therefore all references to a “step” or “steps” of a process have an inherent antecedent basis in the mere recitation of the term ‘process’ or a like term. Accordingly, any reference in a claim to a ‘step’ or ‘steps’ of a process has sufficient antecedent basis.

The term “invention” and the like mean “the one or more inventions disclosed in this specification”, unless expressly specified otherwise.

The terms “an embodiment”, “embodiment”, “embodiments”, “the embodiment”, “the embodiments”, “one or more embodiments”, “some embodiments”, “certain embodiments”, “one embodiment”, “another embodiment” and the like mean “one or more (but not all) embodiments of the disclosed invention(s)”, unless expressly specified otherwise.

The term “variation” of an invention means an embodiment of the invention, unless expressly specified otherwise.

A reference to “another embodiment” in describing an embodiment does not imply that the referenced embodiment is mutually exclusive with another embodiment (e.g., an embodiment described before the referenced embodiment), unless expressly specified otherwise.

The terms “including”, “comprising” and variations thereof mean “including but not limited to”, unless expressly specified otherwise.

The terms “a”, “an” and “the” mean “one or more”, unless expressly specified otherwise.

The term “plurality” means “two or more”, unless expressly specified otherwise.

The term “herein” means “in the present specification, including anything which may be incorporated by reference”, unless expressly specified otherwise.

The phrase “at least one of”, when such phrase modifies a plurality of things (such as an enumerated list of things), means any combination of one or more of those things, unless expressly specified otherwise. For example, the phrase “at least one of a widget, a car and a wheel” means either (i) a widget, (ii) a car, (iii) a wheel, (iv) a widget and a car, (v) a widget and a wheel, (vi) a car and a wheel, or (vii) a widget, a car and a wheel. The phrase “at least one of”, when such phrase modifies a plurality of things, does not mean “one of each of” the plurality of things.

Numerical terms such as “one”, “two”, etc. when used as cardinal numbers to indicate quantity of something (e.g., one widget, two widgets), mean the quantity indicated by that numerical term, but do not mean at least the quantity indicated by that numerical term. For example, the phrase “one widget” does not mean “at least one widget”, and therefore the phrase “one widget” does not cover, e.g., two widgets.

The phrase “based on” does not mean “based only on”, unless expressly specified otherwise. In other words, the phrase “based on” describes both “based only on” and “based at least on”. The phrase “based at least on” is equivalent to the phrase “based at least in part on”.

The term “represent” and like terms are not exclusive, unless expressly specified otherwise. For example, the term “represents” do not mean “represents only”, unless expressly specified otherwise. In other words, the phrase “the data represents a credit card number” describes both “the data represents only a credit card number” and “the data represents a credit card number and the data also represents something else”.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

The term “e.g.” and like terms mean “for example”, and thus does not limit the term or phrase it explains. For example, in the sentence “the computer sends data (e.g., instructions, a data structure) over the Internet”, the term “e.g.” explains that “instructions” are an example of “data” that the computer may send over the Internet, and also explains that “a data structure” is an example of “data” that the computer may send over the Internet. However, both “instructions” and “a data structure” are merely examples of “data”, and other things besides “instructions” and “a data structure” can be “data”.

The term “i.e.” and like terms mean “that is”, and thus limits the term or phrase it explains. For example, in the sentence “the computer sends data (i.e., instructions) over the Internet”, the term “i.e.” explains that “instructions” are the “data” that the computer sends over the Internet.

Any given numerical range shall include whole and fractions of numbers within the range. For example, the range “1 to 10” shall be interpreted to specifically include whole numbers between 1 and 10 (e.g., 2, 3, 4, . . . 9) and non-whole numbers (e.g., 1.1, 1.2, . . . 1.9).

### II. Determining

The term “determining” and grammatical variants thereof (e.g., to determine a price, determining a value, determine an object which meets a certain criterion) is used in an extremely broad sense. The term “determining” encompasses a wide variety of actions and therefore “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing, and the like.

The term “determining” does not imply certainty or absolute precision, and therefore “determining” can include estimating, extrapolating, predicting, guessing and the like.

The term “determining” does not imply that mathematical processing must be performed, and does not imply that numerical methods must be used, and does not imply that an algorithm or process is used.

The term “determining” does not imply that any particular device must be used. For example, a computer need not necessarily perform the determining.

### III. Indication

The term “indication” is used in an extremely broad sense. The term “indication” may, among other things, encompass a sign, symptom, or token of something else.

The term “indication” may be used to refer to any indicia and/or other information indicative of or associated with a subject, item, entity, and/or other object and/or idea.

As used herein, the phrases “information indicative of” and “indicia” may be used to refer to any information that represents, describes, and/or is otherwise associated with a related entity, subject, or object.

Indicia of information may include, for example, a symbol, a code, a reference, a link, a signal, an identifier, and/or any combination thereof and/or any other informative representation associated with the information.

In some embodiments, indicia of information (or indicative of the information) may be or include the information itself and/or any portion or component of the information. In some embodiments, an indication may include a request, a solicitation, a broadcast, and/or any other form of information gathering and/or dissemination.

### IV. Forms of Sentences

Where a limitation of a first claim would cover one of a feature as well as more than one of a feature (e.g., a limitation such as “at least one widget” covers one widget as well as more than one widget), and where in a second claim that depends on the first claim, the second claim uses a definite article “the” to refer to the limitation (e.g., “the widget”), this does not imply that the first claim covers only one of the feature, and this does not imply that the second claim covers only one of the feature (e.g., “the widget” can cover both one widget and more than one widget).

When an ordinal number (such as “first”, “second”, “third” and so on) is used as an adjective before a term, that ordinal number is used (unless expressly specified otherwise) merely to indicate a particular feature, such as to distinguish that particular feature from another feature that is described by the same term or by a similar term. For example, a “first widget” may be so named merely to distinguish it from, e.g., a “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; and (3) does not indicate that either widget ranks above or below any other, as in importance or quality. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

When a single device or article is described herein, more than one device/article (whether or not they cooperate) may alternatively be used in place of the single device/article that is described. Accordingly, the functionality that is described as being possessed by a device may alternatively be possessed by more than one device/article (whether or not they cooperate).

Similarly, where more than one device or article is described herein (whether or not they cooperate), a single device/article may alternatively be used in place of the more than one device or article that is described. For example, a plurality of computer-based devices may be substituted with a single computer-based device. Accordingly, the various functionality that is described as being possessed by more than one device or article may alternatively be possessed by a single device/article.

The functionality and/or the features of a single device that is described may be alternatively embodied by one or more other devices which are described but are not explicitly described as having such functionality/features. Thus, other embodiments need not include the described device itself, but rather can include the one or more other devices which would, in those other embodiments, have such functionality/features.

### V. Disclosed Examples and Terminology are not Limiting

Neither the Title nor the Abstract in this specification is intended to be taken as limiting in any way as the scope of the disclosed invention(s). The title and headings of sections provided in the specification are for convenience only, and are not to be taken as limiting the disclosure in any way.

Numerous embodiments are described in the present application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognise that the disclosed invention(s) may be practised with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

The present disclosure is not a literal description of all embodiments of the invention(s). Also, the present disclosure is not a listing of features of the invention(s) which must be present in all embodiments.

Devices that are described as in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for long period of time (e.g. weeks at a time). In addition, devices that are in communication with each other may communicate directly or indirectly through one or more intermediaries.

A description of an embodiment with several components or features does not imply that all or even any of such components/features are required. On the contrary, a variety of optional components are described to illustrate the wide variety of possible embodiments of the present invention(s). Unless otherwise specified explicitly, no component/feature is essential or required.

Although process steps, operations, algorithms or the like may be described in a particular sequential order, such processes may be configured to work in different orders. In other words, any sequence or order of steps that may be explicitly described does not necessarily indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention(s), and does not imply that the illustrated process is preferred.

Although a process may be described as including a plurality of steps, that does not imply that all or any of the steps are preferred, essential or required. Various other embodiments within the scope of the described invention(s) include other processes that omit some or all of the described steps. Unless otherwise specified explicitly, no step is essential or required.

Although a process may be described singly or without reference to other products or methods, in an embodiment the process may interact with other products or methods. For example, such interaction may include linking one business model to another business model. Such interaction may be provided to enhance the flexibility or desirability of the process.

Although a product may be described as including a plurality of components, aspects, qualities, characteristics and/or features, that does not indicate that any or all of the plurality are preferred, essential or required. Various other embodiments within the scope of the described invention(s) include other products that omit some or all of the described plurality.

An enumerated list of items (which may or may not be numbered) does not imply that any or all of the items are mutually exclusive, unless expressly specified otherwise. Likewise, an enumerated list of items (which may or may not be numbered) does not imply that any or all of the items are comprehensive of any category, unless expressly specified otherwise. For example, the enumerated list “a computer, a laptop, a PDA” does not imply that any or all of the three items of that list are mutually exclusive and does not imply that any or all of the three items of that list are comprehensive of any category.

An enumerated list of items (which may or may not be numbered) does not imply that any or all of the items are equivalent to each other or readily substituted for each other.

All embodiments are illustrative, and do not imply that the invention or any embodiments were made or performed, as the case may be.

### VI. Computing

It will be readily apparent to one of ordinary skill in the art that the various processes described herein may be implemented by, e.g., appropriately programmed general purpose computers, special purpose computers and computing devices. Typically a processor (e.g., one or more microprocessors, one or more micro-controllers, one or more digital signal processors) will receive instructions (e.g., from a memory or like device), and execute those instructions, thereby performing one or more processes defined by those instructions.

A “processor” means one or more microprocessors, central processing units (CPUs), computing devices, micro-controllers, digital signal processors, or like devices or any combination thereof.

Thus a description of a process is likewise a description of an apparatus for performing the process. The apparatus that performs the process can include, e.g., a processor and those input devices and output devices that are appropriate to perform the process.

Further, programs that implement such methods (as well as other types of data) may be stored and transmitted using a variety of media (e.g., computer readable media) in a number of manners. In some embodiments, hard-wired circuitry or custom hardware may be used in place of, or in combination with, some or all of the software instructions that can implement the processes of various embodiments. Thus, various combinations of hardware and software may be used instead of software only.

The term “computer-readable medium” refers to any medium, a plurality of the same, or a combination of different media, that participate in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fibre optics, including the wires that comprise a system bus coupled to the processor. Transmission media may include or convey acoustic waves, light waves and electromagnetic emissions, such as those generated during radio frequency (RF) and infra-red (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying data (e.g. sequences of instructions) to a processor. For example, data may be (i) delivered from RAM to a processor; (ii) carried over a wireless transmission medium; (iii) formatted and/or transmitted according to numerous formats, standards or protocols, such as Ethernet (or IEEE 802.3), SAP, ATP, Bluetooth™, and TCP/IP, TDMA, CDMA, and 3G; and/or (iv) encrypted to ensure privacy or prevent fraud in any of a variety of ways well known in the art.

Thus a description of a process is likewise a description of a computer-readable medium storing a program for performing the process. The computer-readable medium can store (in any appropriate format) those program elements which are appropriate to perform the method.

Just as the description of various steps in a process does not indicate that all the described steps are required, embodiments of an apparatus include a computer/computing device operable to perform some (but not necessarily all) of the described process.

Likewise, just as the description of various steps in a process does not indicate that all the described steps are required, embodiments of a computer-readable medium storing a program or data structure include a computer-readable medium storing a program that, when executed, can cause a processor to perform some (but not necessarily all) of the described process.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) could be used to store and manipulate the data types described herein. Likewise, object methods or behaviours of a database can be used to implement various processes, such as the described herein. In addition, the databases may, in a known manner, be stored locally or remotely from a device which accesses data in such a database.

Various embodiments can be configured to work in a network environment including a computer that is in communication (e.g., via a communications network) with one or more devices. The computer may communicate with the devices directly or indirectly, via any wired or wireless medium (e.g. the Internet, LAN, WAN or Ethernet, Token Ring, a telephone line, a cable line, a radio channel, an optical communications line, commercial on-line service providers, bulletin board systems, a satellite communications link, a combination of any of the above). Each of the devices may themselves comprise computers or other computing devices that are adapted to communicate with the computer. Any number and type of devices may be in communication with the computer.

In an embodiment, a server computer or centralised authority may not be necessary or desirable. For example, the present invention may, in an embodiment, be practised on one or more devices without a central authority. In such an embodiment, any functions described herein as performed by the server computer or data described as stored on the server computer may instead be performed by or stored on one or more such devices.

Where a process is described, in an embodiment the process may operate without any user intervention. In another embodiment, the process includes some human intervention (e.g., a step is performed by or with the assistance of a human).

It should be noted that where the terms “server”, “secure server” or similar terms are used herein, a communication device is described that may be used in a communication system, unless the context otherwise requires, and should not be construed to limit the present invention to any particular communication device type. Thus, a communication device may include, without limitation, a bridge, router, bridge-router (router), switch, node, or other communication device, which may or may not be secure.

It should also be noted that where a flowchart is used herein to demonstrate various aspects of the invention, it should not be construed to limit the present invention to any particular logic flow or logic implementation. The described logic may be partitioned into different logic blocks (e.g., programs, modules, functions, or subroutines) without changing the overall results or otherwise departing from the true scope of the invention. Often, logic elements may be added, modified, omitted, performed in a different order, or implemented using different logic constructs (e.g., logic gates, looping primitives, conditional logic, and other logic constructs) without changing the overall results or otherwise departing from the true scope of the invention.

Various embodiments of the invention may be embodied in many different forms, including computer program logic for use with a processor (e.g., a microprocessor, microcontroller, digital signal processor, or general purpose computer and for that matter, any commercial processor may be used to implement the embodiments of the invention either as a single processor, serial or parallel set of processors in the system and, as such, examples of commercial processors include, but are not limited to Merced™, Pentium™ Pentium II™, Xeon™, Celeron™, Pentium Pro™, Efficeon™, Athlon™, AMD™ and the like), programmable logic for use with a programmable logic device (e.g., a Field Programmable Gate Array (FPGA) or other PLD), discrete components, integrated circuitry (e.g., an Application Specific Integrated Circuit (ASIC)), or any other means including any combination thereof. In an exemplary embodiment of the present invention, predominantly all of the communication between users and the server is implemented as a set of computer program instructions that is converted into a computer executable form, stored as such in a computer readable medium, and executed by a microprocessor under the control of an operating system.

Computer program logic implementing all or part of the functionality where described herein may be embodied in various forms, including a source code form, a computer executable form, and various intermediate forms (e.g., forms generated by an assembler, compiler, linker, or locator). Source code may include a series of computer program instructions implemented in any of various programming languages (e.g., an object code, an assembly language, or a high-level language such as Fortran, C, C++, JAVA, or HTML. Moreover, there are hundreds of available computer languages that may be used to implement embodiments of the invention, among the more common being Ada; Algol; APL; awk; Basic; C; C++; Conol; Delphi; Eiffel; Euphoria; Forth; Fortran; HTML; Icon; Java; Javascript; Lisp; Logo; Mathematica; MatLab; Miranda; Modula-2; Oberon; Pascal; Perl; PL/I; Prolog; Python; Rexx; SAS; Scheme; sed; Simula; Smalltalk; Snobol; SQL; Visual Basic; Visual C++; Linux and XML.) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

The computer program may be fixed in any form (e.g., source code form, computer executable form, or an intermediate form) either permanently or transitorily in a tangible storage medium, such as a semiconductor memory device (e.g, a RAM, ROM, PROM, EEPROM, or Flash-Programmable RAM), a magnetic memory device (e.g., a diskette or fixed disk), an optical memory device (e.g., a CD-ROM or DVD-ROM), a PC card (e.g., PCMCIA card), or other memory device. The computer program may be fixed in any form in a signal that is transmittable to a computer using any of various communication technologies, including, but in no way limited to, analog technologies, digital technologies, optical technologies, wireless technologies (e.g., Bluetooth), networking technologies, and inter-networking technologies. The computer program may be distributed in any form as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

Hardware logic (including programmable logic for use with a programmable logic device) implementing all or part of the functionality where described herein may be designed using traditional manual methods, or may be designed, captured, simulated, or documented electronically using various tools, such as Computer Aided Design (CAD), a hardware description language (e.g., VHDL or AHDL), or a PLD programming language (e.g., PALASM, ABEL, or CUPL). Hardware logic may also be incorporated into display screens for implementing embodiments of the invention and which may be segmented display screens, analogue display screens, digital display screens, CRTs, LED screens, Plasma screens, liquid crystal diode screen, and the like.

Programmable logic may be fixed either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM or DVD-ROM), or other memory device. The programmable logic may be fixed in a signal that is transmittable to a computer using any of various communication technologies, including, but in no way limited to, analog technologies, digital technologies, optical technologies, wireless technologies (e.g., Bluetooth), networking technologies, and internetworking technologies. The programmable logic may be distributed as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

“Comprises/comprising” and “includes/including” when used in this specification is taken to specify the presence of stated features, integers, steps or components but does not preclude the presence or addition of one or more other features, integers, steps, components or groups thereof. Thus, unless the context clearly requires otherwise, throughout the description and the claims, the words ‘comprise’, ‘comprising’, ‘includes’, ‘including’ and the like are to be construed in an inclusive sense as opposed to an exclusive or exhaustive sense; that is to say, in the sense of “including, but not limited to”.

We claim:

1. A method of optimising energy management of a building heating, ventilation and air conditioning (HVAC) system, the method comprising the steps of:
monitoring a set of actual building environment parameters of at least one individual building in response to a naturally occurring impulse of the HVAC system;
generating a thermal profile of the at least one individual building using the monitored set of actual building environment parameters as inputs;
wherein the generated thermal profile comprises a calculation of energy required to maintain a predetermined temperature set point as a function of the difference between source energy, Eᵢₙ, put into the at least one building and drain energy, Eₗₒₛₜ, lost from the building.

2. A method as claimed in claim 1 wherein the actual building environment parameters comprise one or a combination of:
air temperature of the building;
one or more surface temperatures of the building;
relative humidity;
movement detection;
HVAC schedule information;
building energy cost profile information;
one or more remote DR request;
predicted regional weather;
building occupant comfort coordination information;
output of the generated thermal profile.

3. (canceled)

4. A method as claimed in claim 1 wherein the naturally occurring impulse corresponds to one or a combination of:
at least one remote DR request event;
lights being turned on/off at the start/end of the day;
building occupants arriving/departing at the start/end of the day;
at least one heat-producing system that is independent of the HVAC system switched on/off within the building;
the HVAC system being switched on/off at the start/end of the day.

5. A method as claimed in claim 1 wherein the source energy, Eᵢₙ, put into the at least one building comprises the sum of heat received from an external energy supplier and heat generated by people and equipment occupying the building and wherein the drain energy, Eₗₒₛₜ, lost from the building comprises:
(T_{inside building}−T_{outside building})×Insulation Factor,
where T is in units of ° C. and Insulation Factor is in units of J/° C.

6. (canceled)

7. A method as claimed in claim 5 wherein the Insulation Factor is dependent on one or a combination of the following building attributes:
one or more of presence, absence, quality of insulation in roof/wall cavities;
air leaks directly to outside;
external glass;
orientation of building with respect to direct sunlight;
any shade;
abnormal airflow/wind;
altitude.

8. A method as claimed in claim 1 further comprising the step of:
repeating the steps of claim 1 for a plurality of individual buildings to provide a set of resultant generated thermal profiles and;
integrating the resultant generated thermal profiles to provide at least one regional energy usage trend.

9. A building heating, ventilation and air conditioning (HVAC) energy management system, which comprises:
environmental monitoring equipment for monitoring a set of actual building environment parameters of at least one individual building following a naturally occurring impulse of the HVAC system;
a computer server comprising data processing components for generating a thermal profile of the at least one individual building using the monitored set of actual building environment parameters as inputs;
wherein the generated thermal profile comprises a calculation of energy required to maintain a predetermined temperature set point as a function of the difference between source energy, Eᵢₙ, put into the at least one building and drain energy, Eₗₒₛₜ, lost from the building.

10. (canceled)

11. A computer program product comprising:
a computer usable medium having computer readable program code and computer readable system code embodied on said medium for optimising energy management of a building heating, ventilation and air conditioning (HVAC) system within a data processing system, said computer program product comprising computer readable code within said computer usable medium for performing the method steps as claimed in claim 1.

12. A method of dynamically responding to a Demand Response (DR) request of a commercial energy system to reduce energy consumption of at least one energy consuming appliance, equipment and/or device, the method comprising the steps of:
providing the DR request with an associated priority;
controlling at least one control device operably connected to energy consuming appliances, equipment and/or devices of an individual building in accordance with predetermined criteria based on the associated priority.

13. A method as claimed in claim 12 wherein the priority is selected from a plurality of levels.

14. A method as claimed in claim 12 wherein the associated priority is selected from one or a combination of the following levels:
high;
medium, or
low.

15. A method as claimed in claim 14 wherein the predetermined criteria comprise one or a combination of:
complete lock out of a user from the at least one control device of the individual building for a high priority DR request;
invoking a first restricted set point range of the at least one control device for a medium priority DR request with an option for the user to opt out of the DR request;
invoking a second restricted set point range of the at least one control device for a low priority DR request with an option for the user to opt in to the DR request.

16. A method as claimed in claim 15 wherein the predetermined criteria further comprise one or a combination of:
a PIN code being required to unlock a user from the at least one control device of the individual building for a high priority DR request;
reporting a decision by the user to opt out of a medium priority DR request to the originator of the DR request;
the decision to opt in to a low priority DR request being based on circumstances local to the individual building.

17. A method as claimed in claim 15 wherein the first restricted set point range is more restrictive than the second restricted set point range.

18. A method as claimed in claim 12 wherein the predetermined criteria further comprise one or a combination of:
turning the at least one energy consuming appliance, equipment and/or device off altogether;
turning off a heating/cooling element of the at least one energy consuming appliance, equipment and/or device and keeping a fan of the at least one energy consuming appliance, equipment and/or device running; and
wherein the at least one energy consuming appliance, equipment and/or device is one or a combination of:
a HVAC system;
a lighting system;
a hot water service/system.

19. (canceled)

20. A method as claimed in claim 12 wherein the at least one control device comprises a thermostat.

21. A building energy management system adapted to dynamically respond to a Demand Response (DR) request of a commercial energy system to reduce energy consumption of at least one energy consuming appliance, equipment and/or device, the system comprising:
computer data network means for providing the DR request with an associated priority level;
at least one control device operably connected to the at least one energy consuming appliance, equipment and/or device of an individual building adapted to receive the DR request and control the at least one energy consuming appliance, equipment and/or device of the building in accordance with predetermined criteria based on the associated priority level.

22. A building energy management system as claimed in claim 21 wherein the at least one energy consuming appliance, equipment and/or device is one or a combination of:
a HVAC system;
a lighting system;
a hot water service/system; and
wherein the at least one control device comprises a thermostat.

23. (canceled)

24. (canceled)

25. A computer program product comprising:
a computer usable medium having computer readable program code and computer readable system code embodied on said medium for dynamically responding to a Demand Response (DR) request of a commercial energy system to reduce energy consumption of a building within a data processing system, said computer program product comprising computer readable code within said computer usable medium for performing the method steps of claim 12 including the steps of:
providing the DR request with an associated priority level;
controlling at least one energy consuming appliance, equipment and/or device of an individual building in accordance with predetermined criteria based on the associated priority level;
wherein the at least one energy consuming appliance, equipment and/or device is one or a combination of:
a HVAC system;
a lighting system;
a hot water service/system; and
wherein the at least one control device comprises a thermostat.

26.-29. (canceled)
